(19) United States
(12) Patent Application Publication
(10) Pub. No.: US 2016/0373331 A1
(43) Pub. Date: Dec. 22, 2016

(54) INFORMATION PROCESSING SYSTEM AND METHOD OF CONTROLLING INFORMATION PROCESSING SYSTEM

(71) Applicant: FUJITSU LIMITED, Kawasaki-shi (JP)

(72) Inventor: Keiji Miyazaki, Kawasaki (JP)

(73) Assignee: FUJITSU LIMITED, Kawasaki-shi (JP)

(21) Appl. No.: 15/164,920

(22) Filed: May 26, 2016

(30) Foreign Application Priority Data
Jun. 19, 2015 (JP) 2015-124043

(51) Int. Cl. H04L 12/26; H04L 12/931

(52) U.S. Cl. CPC H04L 43/0876; H04L 43/04; H04L 49/354

(57) ABSTRACT

An information processing apparatus configured to adjust a phase relation between a data signal and a strobe signal includes a processor and memory. The memory stores instructions for causing the processor to execute identifying, for each of a plurality of candidates for reference values used to perform a determination regarding a value of the data signal, at least one phase difference between the data signal and the strobe signal for successfully acquiring the data signal according to the strobe signal, determining a reference value of the plurality of candidates for which a period for successfully acquiring the data signal is longer than periods for any other candidates based on the identified phase difference for each candidate, and adjusting the phase relation between the data signal and the strobe signal based on the period for the determined reference value.

### CROSS-REFERENCE TO RELATED APPLICATION

This application is based upon and claims the benefit of priority of the prior Japanese Patent Application No. 2015-124043, filed on Jun. 19, 2015, the entire contents of which are incorporated herein by reference.

### FIELD

The embodiments discussed herein pertain to an information processing system and a method of controlling an information processing system.

### BACKGROUND

A data center employs switches and routers to consolidate data lines from servers and storage devices in the data center in a step-by-step manner. And the data center transmits and receives packets to and from apparatuses outside of the data center.

Techniques are proposed to monitor the amount of packets transferred in the internal network in the data center and to monitor the amount of packets transferred between the data center and the external network (See patent documents 1 to 3).

The following patent document describes conventional techniques related to the techniques described herein.

### PATENT DOCUMENT

[Patent document 1] Japanese Laid-open Patent Publication No. 2010-68367

[Patent document 2] Japanese Laid-open Patent Publication No. 2002-232481

[Patent document 3] Japanese Laid-open Patent Publication No. 2012-226468

### SUMMARY

According to one embodiment, it is provided an information processing system.

The information processing system includes a relay apparatus configured to relay data between an internal network of the information processing system and an external network connecting with an external apparatus of the information processing system, a switching apparatus configured to connect with the relay apparatus via the internal network, a plurality of devices connected with a plurality ports of the switching apparatus via the internal network and an administration apparatus configured to administer information of an amount of data transmitted in the internal network.

The administration apparatus includes a processor, and memory storing instructions for causing the processor to execute gathering information of an amount of data transmitted through the switching apparatus from the switching apparatus for each of the plurality of devices connected with the plurality ports of the switching apparatus.

The processor further executes calculating an amount of data transmitted between a first device and a second device of the plurality devices based on the gathered information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating a configuration of an information processing system according to an embodiment;

FIG. 2 is a diagram schematically illustrating configurations of an administration system according to an embodiment;

FIG. 3 is a diagram illustrating an example of data stored in a switch connection information table according to an embodiment;

FIG. 4 is a diagram illustrating an example of data stored in a packet amount counter table according to an embodiment;

FIG. 5 is a diagram illustrating an example of data stored in a packet amount by apparatus table according to an embodiment;

FIG. 6 is a diagram illustrating an example of data stored in a packet amount calculation result table according to an embodiment;

FIG. 7 is a functional block diagram illustrating an administration apparatus according to an embodiment;

FIG. 8 is a flowchart of processes performed by an administration apparatus according to an embodiment;

FIG. 9 is a diagram illustrating connection relations of apparatuses for packet amount calculation according to an embodiment;

FIG. 10 is a diagram schematically illustrating flows of packets in packet amount calculation according to an embodiment;

FIG. 11 is a diagram illustrating an example of amounts of packets input/output between apparatuses according to an embodiment;

FIG. 12 is a diagram illustrating an example of calculation results of amounts of packets output from apparatuses according to an embodiment;

FIG. 13 is a diagram illustrating connection relations of apparatuses for packet amount calculation according to an embodiment;

FIG. 14 is a diagram schematically illustrating flows of packets in packet amount calculation according to an embodiment;

FIG. 15 is a diagram illustrating an example of amounts of packets input/output between apparatuses according to an embodiment;

FIG. 16 is a diagram illustrating an example of calculation results of amounts of packets output from apparatuses according to an embodiment;

FIG. 17 is a diagram illustrating an example of amounts of packets input/output between apparatuses according to an embodiment;

FIG. 18 is a diagram illustrating an example of calculation results of amounts of packets input into or output from apparatuses according to an embodiment; and

FIG. 19 is a diagram illustrating connection relations of apparatuses for packet amount calculation according to an embodiment.

### DESCRIPTION OF EMBODIMENTS

Switches used in data centers can measure amounts of packets per port transmitted in the data centers. Therefore, the amounts of packets input into or output from a specified server can be measured. In addition, the amount of packets output from the specified server to an external network can be determined from the statistics stored in the switch connected with the specified server. However, the switch cannot measure the amounts of packets transmitted between specified servers or between a specified server and a storage apparatus in the data center. In addition, a switch or a router cannot be used to measure the amounts of packets transmitted from a specified apparatus in the external network to each server in the data center. A so-called packet capture technique can be used to calculate the amounts of packets transmitted between servers in the data center by determining the sender and the receiver of a packet and monitoring transmitted packets and received packets. However, since the number of mirror ports of a switch which can be used for the packet capture technique is limited, it is not practical to use the technique to monitor packets transmitted through each port of plural switches in the data center. Therefore, since the amount of packets transmitted between specified apparatuses cannot be measured as described above, the isolations of the controls of congestions or emergency failures occurred in the data center cannot be achieved. One aspect of the present invention lies in providing an information processing system capable of calculating the amounts of packets transmitted between apparatuses in the internal network. Embodiments are described below with reference to the drawings. Configurations of the following embodiments are exemplifications, and the present apparatus is not limited to the configurations of the embodiments.

### First Embodiment

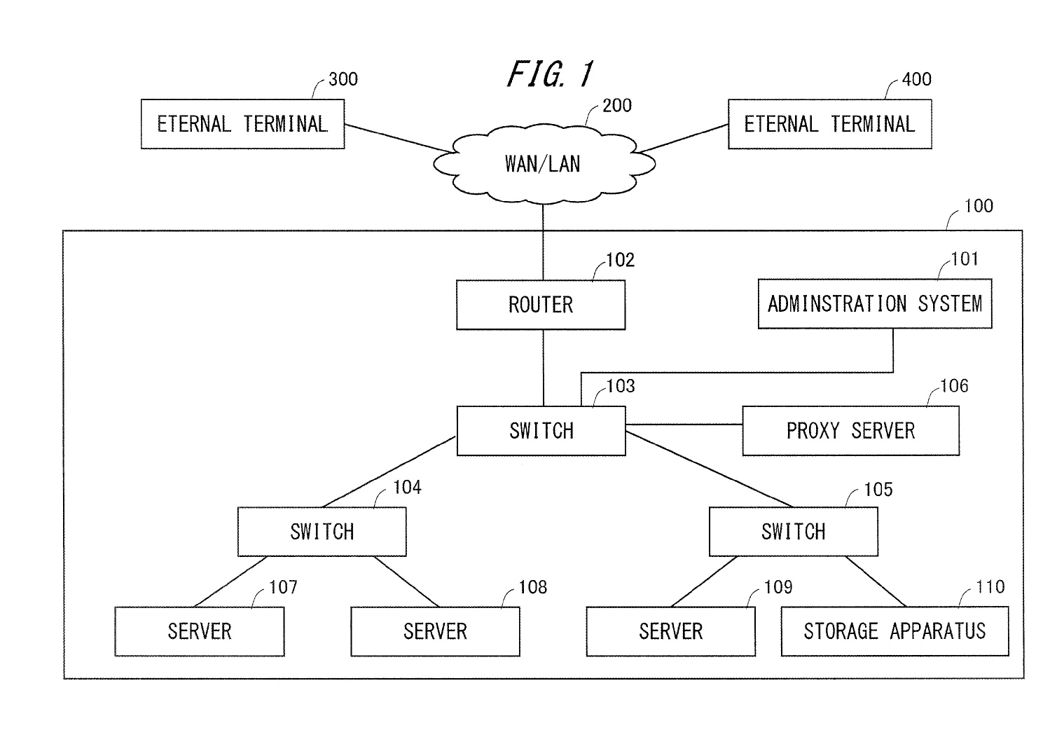

A data center 100 as an example of an information processing system according to the first embodiment is described below. As illustrated in the schematic configuration diagram in FIG. 1, the data center 100 includes an administration system 101, a router 102, switches 103, 104 and 105, a proxy server 106, servers 107, 108 and 109 and a storage apparatus 110. In addition, the apparatuses in the data center 100 are connected with each other to form an internal network. The router 102 is connected with a WAN (Wide Area Network)/LAN (Local Area Network) 200 as an example of an external network. And the router 102 is connected with external terminals 300, 400 via the WAN/LAN 200. It is noted that the router 102 corresponds to an example of a relay apparatus which relays data between the external network and the internal network.

The router 102 is connected with the switch 103 in data center 100. As illustrated in FIG. 1, the switch 103 is connected with the administration system 101, the proxy server 104 and the switches 103 and 104. In addition, the switch 105 is connected with the servers 107 and 108 as examples of a plurality of devices. The switch 106 is connected with the server 109 and the storage apparatus 110. Each port of the switches 103 to 105 is connected with various elements. Further, the switches 103 to 105 include a function for measuring and storing the amount of packets transmitted through each port. It is noted that the switches 103 to 105 correspond to examples of switching apparatuses connected with relay apparatuses via the internal network.

The external terminals 300 and 400 transmit packets to and receive data from the servers 107 to 109 in the data center 100. It is noted that the external terminals 300 and 400 correspond to examples of external apparatuses. The information such as data to be transmitted, a sender address and a destination address is included in a packet. The external terminals 300 and 400 transmit, for example, packets in which the proxy server 106 in the data center 100 is specified as the destination of the packets. The packets transmitted from the external terminals 300 and 400 are transferred to the router 102 in the data center 100 via the WAN/LAN 200.

The router 102 retains a routing table in which the connection information for each element in the internal network in the data center 100 is stored. Therefore, the router 102 transfers the packets received from the WAN/LAN 200 according to the connection information stored in the routing table.

When the router 102 receives the packets transmitted from the external terminals 300 and 400, the router 102 refers to the routing table to determine the destinations of the packets based on the information of the destination addresses included in the received packets. In the present case, the router 102 determines that the destination of the packets received from the external terminals 300 and 400 is the proxy server 106 and transfers the packets to the proxy server 106 via the switch 103.

The proxy server 106 interprets the payloads of the packets received from the router 102 to determine the destinations of the packets. The proxy server 106 sets the determined destinations as the destinations of the packets and transmits the packets to the destination servers 107 to 109 via the switches 103 and 104 or the switches 103 and 105. It is noted that the proxy server 106 corresponds to an example of a proxy apparatus which stores the data amount information of the data output from each apparatus in the data center 100 to the proxy server 106 as proxy data amount information.

Similarly, when the servers 107 to 109 transmit packets to the external terminals 300 and 400, the servers 107 to 109 transfer the packets to the proxy server 106 via the switches 103 and 104 or the switches 103 and 105. And the proxy server 106 determines the destinations of the packets and transmits the packets to the external terminal 300 or 400 according to the determined destinations via the switch 103, the router 102 and the WAN/LAN 200.

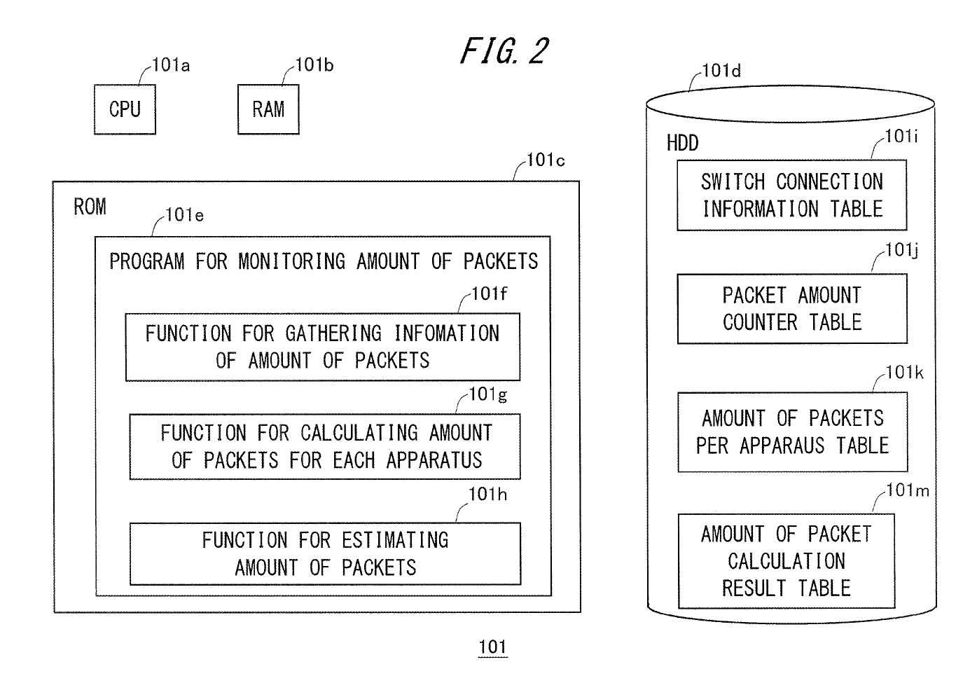

FIG. 2 illustrates the configuration of the administration system 101 according to the present embodiment. The administration system 101 acquires from the switches 103 to 105 statistics regarding the amount of packets input into or output from each port of the switches 103 to 105 and administers the acquired information of the amount of packets. As illustrated in FIG. 2, the administration system 101 includes a CPU 101a, a Random Access Memory (RAM) 101b, a Read Only Memory (ROM) 101c and an HDD 101d.

The CPU 101a deploys various programs stored in the ROM 101c on the RAM 101b to execute various processes of the programs. In addition, the CPU 101a accesses the HDD 101d to acquire data used for the processes when the CPU 101a executes the programs. As illustrated in FIG. 2, a program 101e for monitoring the amount of packets as an example of the programs is stored in the ROM 101c.

The program 101e for monitoring the amount of packets is a program for acquiring statistics data of the amount of packets from the switches 103 to 105 and calculating the amount of packets transmitted between the severs 107 to 109 and the storage apparatus 110 based on the acquired statistics data. The program 101e for monitoring the amount of packets includes a function 101f for gathering information of the amount of packets, a function 101g for calculating the amount of packets for each apparatus and a function 101h for estimating the amount of packets.

The HDD 101d stores data including information of the connections between each port of the switches 103 to 105 and each apparatus in the data center 100, statistics data of the amount of packets acquired from the switches 103 to 105 and the results of the calculations performed based on the statistics data. The data stored in various tables in the HDD 101d. The various tables include a switch connection information table 101i, a packet amount counter table 101j, an amount of packets per apparatus table 101k and an amount of packets calculation result table 101m.

As an example of the present embodiment, the CPU 101a executes the program 101e for monitoring the amount of packets to calculate the amount of packets transmitted between two apparatuses in the data center 100. When the program 101e for monitoring the amount of packets is initiated, the function 101f for gathering the amount of packets gathers the information of the switches connected with the two apparatuses, the IDs of the ports connected with the two apparatuses and the user information of the servers connected with the two apparatuses from the switch connection information table 101i. Next, the function 101f for gathering information of the amount of packets gathers statistics data regarding the amount of packets from the ports indicated by the gathered information. In addition, the function 101f for gathering information of the amount of packets associates the statistics data with the corresponding switch, the port ID and the user of the server and stores the statistics data in the packet amount counter table 101j. It is noted that the function 101f for gathering information of the amount of packets repeats the gathering and storing of statistics data at a predetermined time period such as every hour.

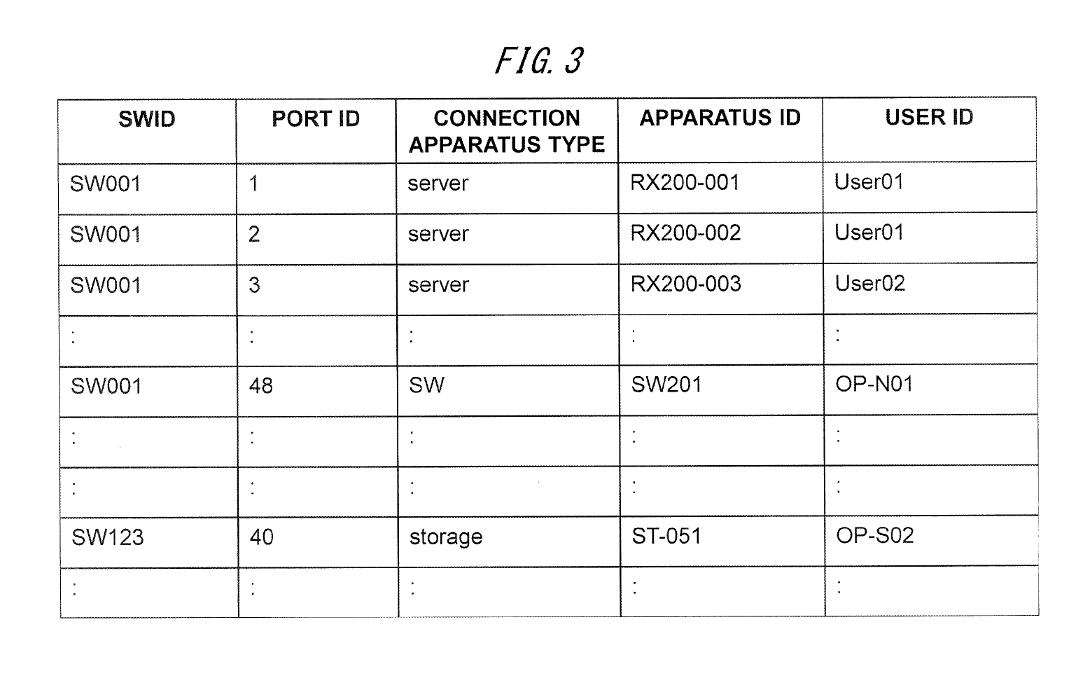

FIG. 3 illustrates an example of the switch connection information table 101i according to the present embodiment. The switch connection information table 101i stores information such as an ID of each switch in the data center 100 (“SWID”), port IDs of each switch, types of apparatuses connected with the ports (“connection apparatus type”), IDs of the apparatuses (“apparatus ID”) and user IDs of the apparatuses. The information is associated with each other in the switch connection information table 101i. It is noted that the information is stored in the switch connection information table 101i in advance before the program 101e for monitoring the amount of packets is executed.

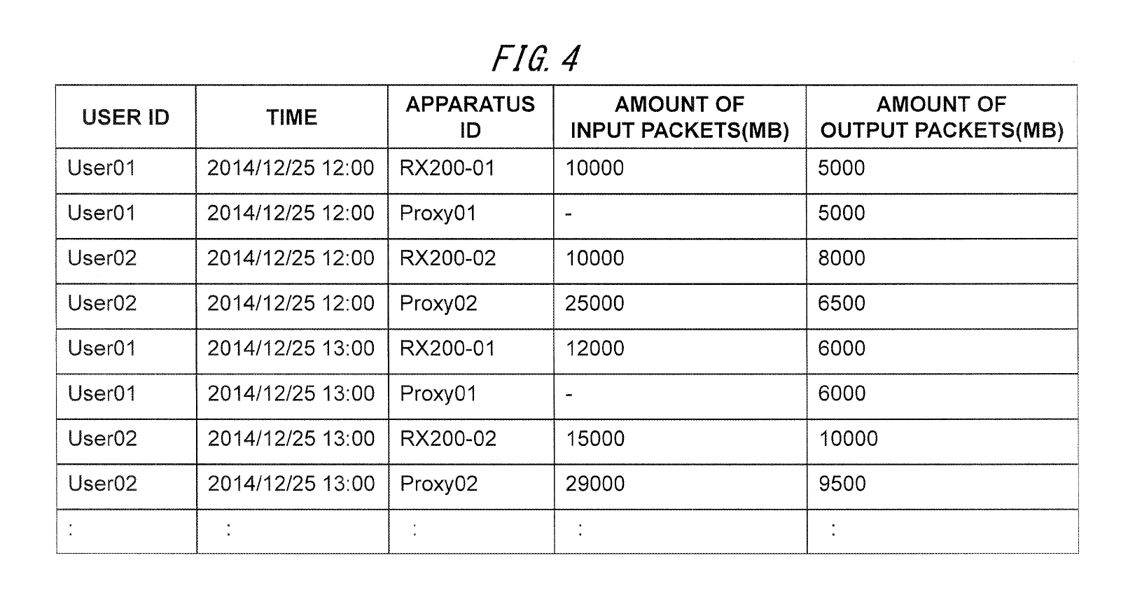

In addition, FIG. 4 illustrates an example of the packet amount counter table 101j according to the present embodiment. The packet amount counter table 101j stores information such as the user IDs, the time when the statistics data of the amount of packets is acquired, the apparatus IDs of the apparatuses from which the statistics data is acquired, the amount of input packets and the amount of output packets. The information is associated with each other in the packet amount counter table 101j.

After the function 101f for gathering information of the amount of packets performs the process as described above, the function 101g for calculating the amount of packets for each apparatus calculates the amount of input packets and the amount of output packets based on the statistics data of the amount of packets stored in the packet amount counter table 101j. In addition, the function 101g for calculating the amount of packets for each apparatus stores the calculated amount of input packets and the calculated amount of output packets in the amount of packets per apparatus table 101k. It is noted that the switches 103 to 105 accumulates the amount of input packets and the amount of output packets transmitted through each port without resetting the amount of input packets and the amount of output packets each time function 101f for gathering information of the amount of packets is executed. However, switches 103 to 105 can be configured to reset the amount of input packets and the amount of output packets each time function 101f for gathering information of the amount of packets is executed.

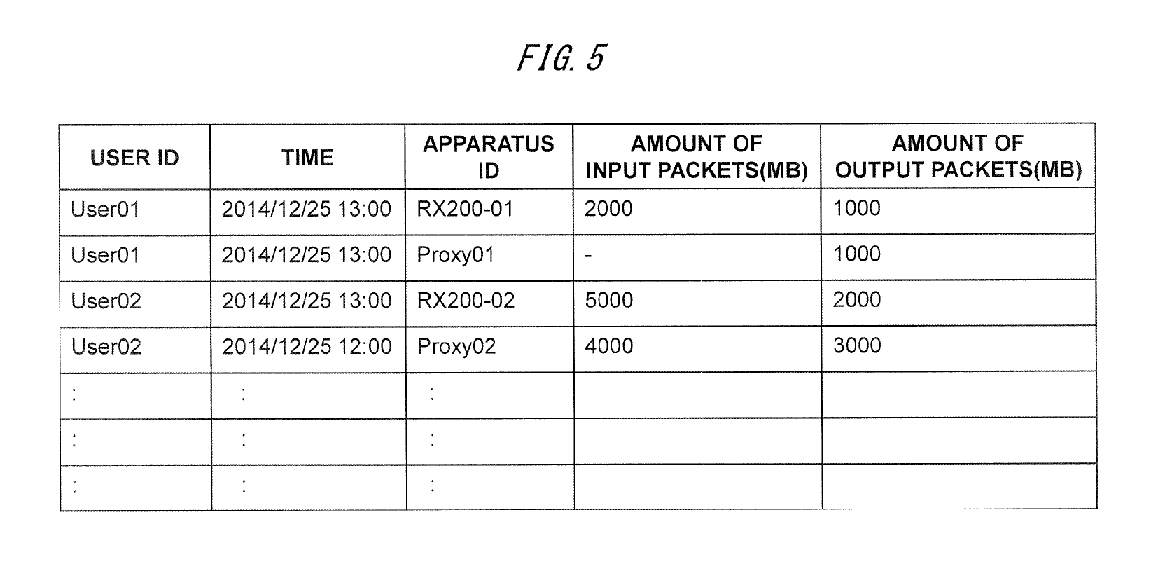

FIG. 5 illustrates an example of the amount of packets per apparatus table 101k according to the present embodiment. The amount of packets per apparatus table 101k stores information such as the user IDs, the time when the statistics data of the amount of packets is acquired, the server IDs of the servers from which the statistics data of the amount of packets is acquired, the amount of input packets and the amount of output packets transmitted within a predetermined time period as described above. The information is associated with each other in the amount of packets per apparatus table 101k.

After the function 101g for calculating the amount of packets for each apparatus performs the process as described above, the function 101h for estimating the amount of packets calculates the amount of input packets and the amount of output packets transmitted between the two apparatuses as described above based on the amount of input packets and the amount of output packets stored in the amount of packets per apparatus table 101k. In addition, the function 101h for estimating the amount of packets stores the calculated amount of packets in the amount of packets calculation result table 101m.

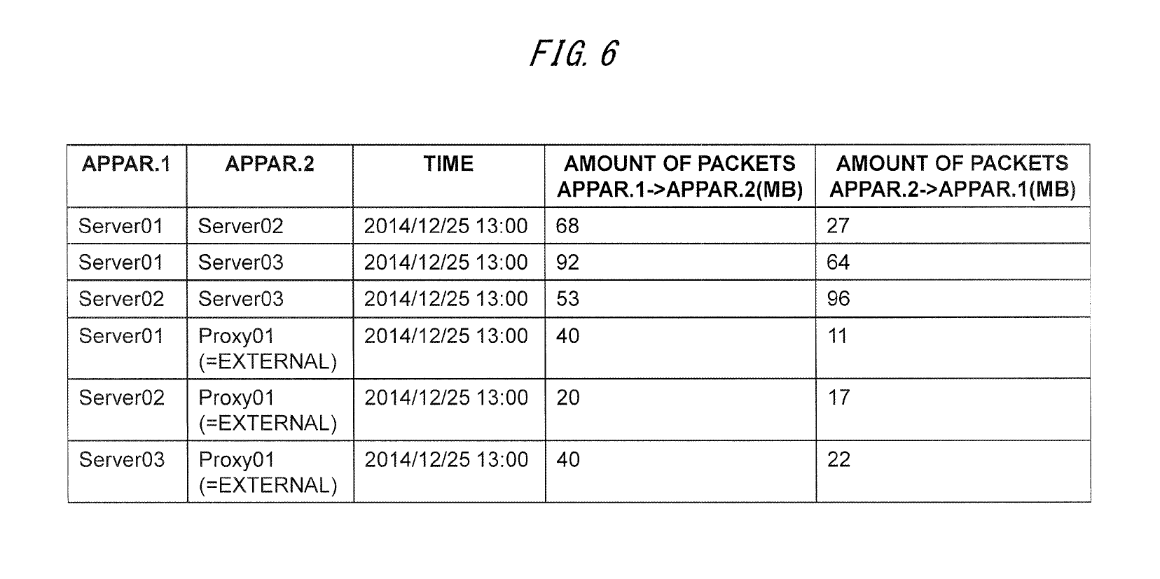

FIG. 6 illustrates an example of the amount of packets calculation result table 101m according to the present embodiment. The amount of packets calculation result table 101m stores information such as the apparatus IDs (“apparatus 1”, “apparatus 2” etc.), the time period during which the amounts of input packets and output packets transmitted between the two apparatuses are calculated, the amount of packets output from the apparatus 1 to the apparatus 2 and the amount of packets output from the apparatus 2 to the apparatus 1. The information is associated with each other in the amount of packets calculation result table 101m. It is noted that the apparatus 1 and apparatus 2 can be arbitrarily selected from the apparatuses in the data center 100 when the program 101e for monitoring the amount of packets is executed to calculate the amounts of packets.

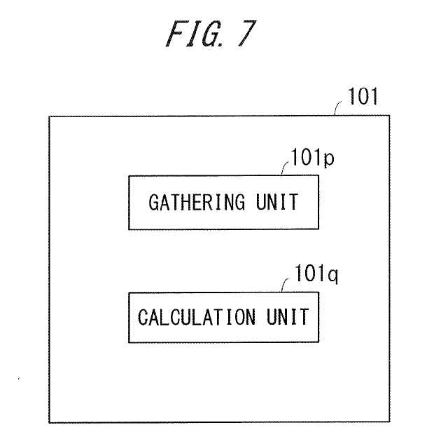

The administration system 101 according to the present embodiment functions as an information processing apparatus which includes a gathering unit 101p and a calculation unit 101q as illustrated in FIG. 7 since the CPU 101a executes the various programs deployed on the RAM 101b to control each element in the administration system. Although it is assumed in the present embodiment that the functions are achieved by a general-purpose CPU, one or more of the functions can be achieved by one or more dedicated CPUs.

In the present embodiment, the gathering unit 101p gathers from the switches 103 to 105 the statistics data of packets transmitted through each port of the switches 103 to 105. The statistics data of packets includes the amount of input packets and the amount of packets transmitted through each port. The calculation unit 101q calculates the amount of packets transmitted between the first apparatus and the second apparatus of the plurality of apparatuses in the data center 100 based on the statistics data of packets gathered by the gathering unit 101p. It is noted that the gathering unit 101p can be configured to gather statistics data of frames or tokens transmitted in the data center 100 as well as packets.

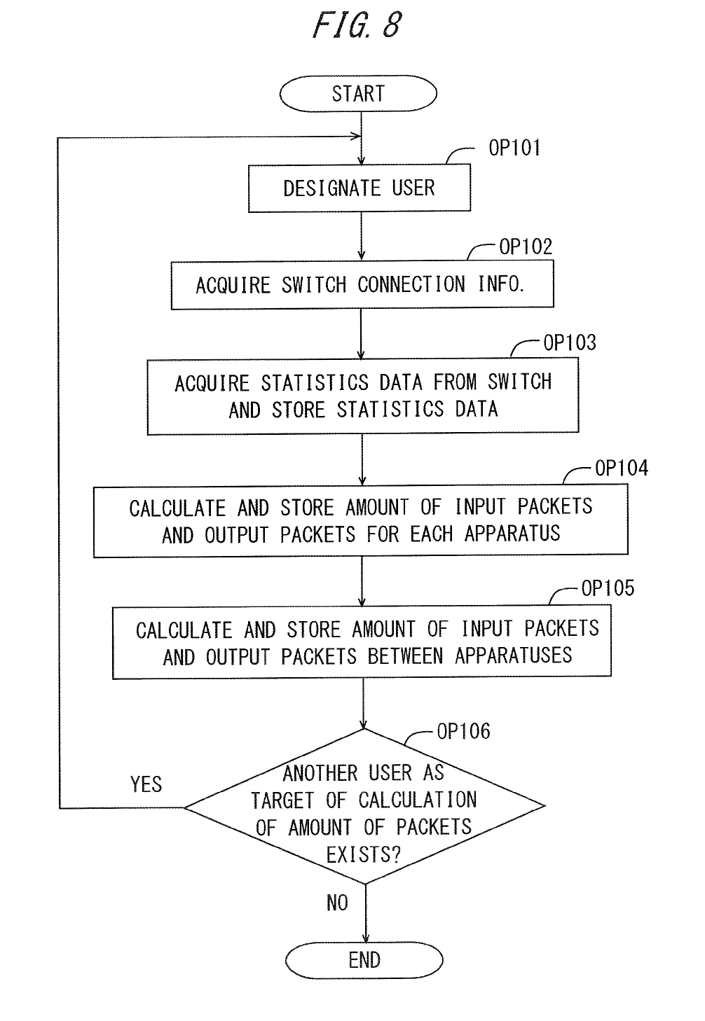

FIG. 8 illustrates a flowchart of processes performed by the administration system 101 in the present embodiment. When the user of the administration system 101 instructs the execution of the program 101e for monitoring the amount of packets, the CPU 101a executes the program 101e for monitoring the amount of packets to initiate performing the processes in the flowchart as illustrated in FIG. 8.

In OP101, the CPU 101a receives a designation of a user of an apparatus in the data center 100 from the user of the administration system 101. The CPU 101a may receive a designation of an apparatus in the data center 100 instead of the user of the apparatus. Next, the process proceeds to OP102.

In OP102, the function 101f for gathering information of the amount of packets in the program 101e for monitoring the amount of packets gathers information associated with the user designated in OP101 from the switch connection information table 101i. Apparatuses used by the designated user, switches and ports connected with the apparatuses can be determined based on the gathered information. Next, the process proceeds to OP103.

In OP103, the function 101f for gathering information of the amount of packets gathers statistics data of the amount of packets transmitted through each port from the switches 103 to 105. And the function 101f for gathering information of the amount of packets stores the gathered statistics data in the packet amount counter table 101j. It is noted that the function 101f for gathering information of the amount of packets gathers the statistics data of the amount of packets transmitted through each port from the switches 103 to 105 every time when the predetermined time period elapses. Since the amount of input packets and the amount of output packets transmitted between the apparatuses per predetermined time period in the present embodiment, it is enough for the function 101f for gathering information of the amount of packets to gather the statistics data at least twice. The times for repeating the gathering of the statics data before the process OP103 is terminated can be arbitrarily determined by configuring the program 101e for monitoring the amount of packets. When the process OP103 is terminated, the process proceeds to OP104.

In OP104, the function 101g for calculating the amount of packets for each apparatus calculates the amounts of packets input into and output from each apparatus per the predetermined time period based on the statistics data gathered in OP103. And the function 101g for calculating the amount of packets for each apparatus stores the calculated amount of input packets and the calculated amount of output packets in the amount of packets per apparatus table 101k. Next, the process proceeds to OP105.

In OP105, the function 101h for estimating the amount of packets calculates the amounts of packets transmitted between the apparatuses based on the amount of input packets and the amount of output packets calculated in OP104. And the function 101h for estimating the amount of packets stores the calculated amounts of input packets and output packets in the amount of packets calculation result table 101m. Next, the process proceeds to OP106.

In OP106, the CPU 101a accepts from the user of the administration system 101 a designation of another user of an apparatus in the data center 100 as a target of the calculation of the amount of packets. When the user of the administration system 101 does not designate another user, the CPU 101a terminates the program 101e for monitoring the amount of packets to finish the processes of the flowchart. On the other hand, when the user of the administration system 101 designates another user, the CPU 101a returns the process to OP101 and selects the user designated in OP106, and then the process proceeds to OP102.

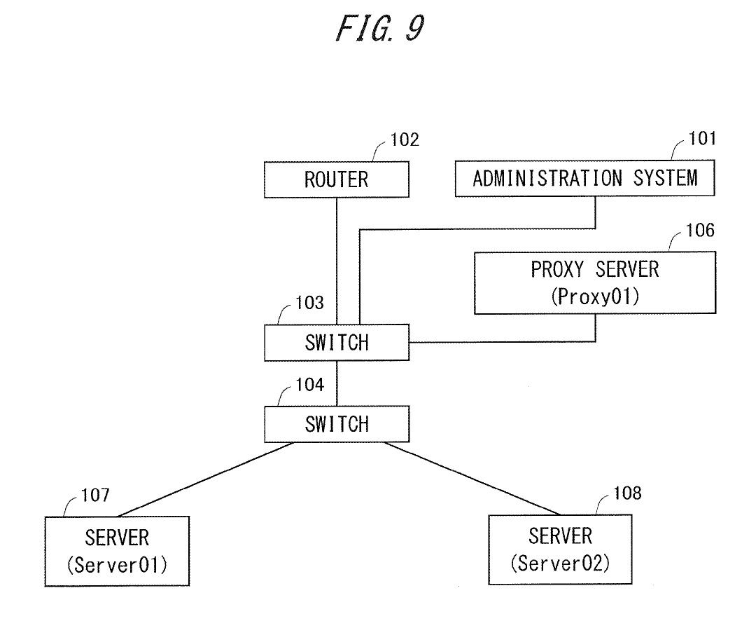

Next, two specific examples of the calculation of the amounts of packets transmitted between the apparatuses are described below. In the first example, the amount of packets transmitted between the servers 107 and 108 in the data center 100 is calculated as illustrated in FIG. 9. In this example, the servers 107 and 108 are connected with the switch 104. It is noted that the following descriptions can be applied to a case in which two apparatuses as the targets of the calculation of the amount of packets are connected with different switches such as the servers 107 and 109. It is noted that the apparatus IDs of the servers 107 and 108 are Server01 and Server02. In addition, the apparatus ID of the proxy server 106 is Proxy01.

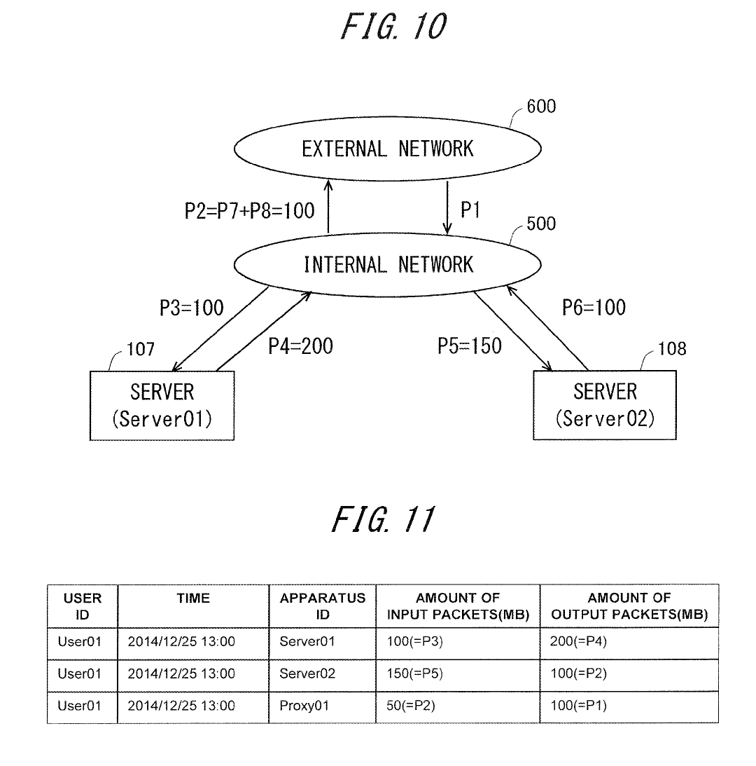

Further, FIG. 10 schematically illustrates the amounts of packets transmitted between the servers, the internal network and the external network as illustrated in FIG. 9 within the predetermined time intervals. In FIG. 10, the internal network 500 represents the network in which each element in the data center 100 is connected with each other. In addition, the external network 600 represents the network outside the data center 100 which is connected with the data center 100.

The administration system 101 executes the program 101e for monitoring the amount of packets and the function 101f for gathering information of the amount of packets gathers information of the amount of packets input into and output from the server 107 and 108 at the predetermined time intervals. Moreover, the administration system 101 uses the function 101f for gathering information of the amount of packets to acquire the information of the amount of packets output from the proxy server 106 to the external network 600 via the switch 103 and the router 102 at the predetermined time intervals.

As illustrated in FIG. 10, the amounts of packets output from the servers 107 and 108 to the internal network 500 at the predetermined time intervals are 200 MB and 100 MB, respectively. And 100 MB packets thereof are output to the external network 600. In addition, the amounts of packets output from the internal network 500 to the servers 107 and 108 at the predetermined time intervals are 100 MB and 150 MB, respectively. It is noted that the administration system 101 acquires the statistics data of the amounts of packets from the switches 103 and 104 and the proxy server 106 to determine the amount of packets regarding each apparatus.

As illustrated in FIG. 10, the amounts of packets P1 to P6 at the predetermined time intervals are defined as follows:

P1=(the amount of packets input into the internal network 500 from the external network 600)
P2=(the amount of packets output from the internal network 500 to the external network 600)
P3=(the amount of packets input into the server 107 from the internal network 500)
P4=(the amount of packets output from the server 107 to the internal network 500)
P5=(the amount of packets input into the server 108 from the internal network 500)
P6=(the amount of packets output from the server 108 to the internal network 500)

The administration system 101 cannot determine the amounts of packets input into the servers 107 and 108 from the external network 600 at the predetermined time intervals based on the acquired statistics data. In addition, it is assumed in the first example that a packet is not lost in the data communication between the internal network 500 and the external network 600. That is, the total amount of packets input into the internal network 500 is equal to the total amount of packets output from the internal network 500 in FIG. 10. In this case, the following formula (1) is obtained.

P1=P2+P3+P5−P4−P6 (1)

In the example of FIG. 10, the amount of packets input into the internal network 500 from the external network 600 P1 is 50 MB.

The administration system 101 uses the function 101g for calculating the amount of packets for each apparatus of the program 101e for monitoring the amount of packets to calculate the amount of packets input into the internal network 500 from the external network 600 P1 within the predetermined time interval including a given time by using the formula (1). The calculation results are stored in the amount of packets per apparatus table 101k. FIG. 11 illustrates an example of data stored in the amount of packets per apparatus table 101k in the example as illustrated in FIG. 10.

Next, the relations between the amount of packets output from the internal network 500 to the external network 600 and the amounts of packets output from the servers 107 and 108 to the internal network 500 are described below. In the example as illustrated in FIGS. 9 and 10, the total amount of packets P4 and P6 output from the servers 107 and 108 to the internal network 500 is 300 MB. And the 100 MB (=P2) packets thereof are output to the external network 600. However, the amount of packets output from the server 107 to the external network 600 and the amount of packets output from the server 108 to the external network 600 are unknown.

In this case, the amount of packets output from the internal network 500 to the external network 600 is distributed by using the ratio of the amounts of packets output from the servers 107 and 108 to the internal network 500. The amounts of packets P7 and P8 are defined as follows:

P7=(the amount of packets output from the server 107 to the external network 600)
P8=(the amount of packets output from the server 108 to the external network 600)

In this case, the function 101g for calculating the amount of packets for each apparatus uses the following formulas (2) and (3) to calculate the amounts of packets P7 and P8.

P7=P2×P4/(P4+P6) (2)

P8=P2×P6/(P4+P6) (3)

The amount of packets output from the server 107 to the external network 600 P7 is calculated by the formula (2): 100×⅔=67 (MB). Similarly, the amount of packets output from the server 108 to the external network 600 P8 is calculated by the formula (3): 100×⅓=33 (MB). It is noted that the values calculated by the formulas (2) and (3) are rounded off to the whole number.

Further, the amounts of packets P9 and P10 are defined as follows:

P9=(the total amount of packets output from the server 107 to the other apparatuses in the data center 100)
P10=(the total amount of packets output from the server 108 to the other apparatuses in the data center 100)
The function 101g for calculating the amount of packets for each apparatus calculates the amounts of packets P9 and P10 by using the following formulas (4) and (5).

P9=P4−P7 (4)

P10=P6−P8 (5)

It is noted that it is assumed in the first example that the targets of the calculation of the amounts of packets in the data center 100 are the server 107 and 108. Therefore, the other apparatus other than the server 107 is the server 108. And the other apparatus other than the server 108 is the server 107.

The total amount of packets output from the server 107 to the other apparatuses in the data center 100 P9 is calculated by the formula (4): 200−67=133 (MB). Similarly, the total amount of packets output from the server 108 to the other apparatuses in the data center 100 is calculated by the formula (5): 100−33=67 (MB).

Next, the relations between the amounts of packets input into the internal network 500 from the external network 600 and the amounts of packets input into the servers 107 and 108 from the internal network 500 are described below. In the example as illustrated in FIGS. 9 and 10, it is unknown what part of the amount of packets input into the internal network 500 from the external network 600 is input into the servers 107 and 108, respectively.

In the first example, the ratio of the amounts of packets output from the internal network 500 to the servers 107 and 108 is used to divide the amount of packets input into the internal network 500 from the external network 600. Here, the amounts of packets P11 and P12 are defined as follows:

P11=(the amount of packets input into the server 107 from the external network 600)
P12=(the amount of packets input into the server 108 from the external network 600)

The function 101g for calculating the amount of packets for each apparatus uses the following formulas (6) and (7) to calculate the amounts of packets P11 and P12.

P11=P1×P3/(P3+P5) (6)

P12=P1×P5/(P3+P5) (7)

The amount of packets input into the server 107 from the external network 600 P11 is calculated by using the formula (6): 50×⅖=20 (MB). Similarly, the amount of packets input into the server 108 from the external network 600 P12 is calculated by using the formula (7): 50×⅗=30 (MB). It is noted that the values calculated by the formulas (6) and (7) are rounded off to the whole number.

In addition, the amounts of packets P13 and P14 are defined as follows:

P13=(the amount of packets input into the server 107 from the apparatuses other than the server 107 in the data center 100)
P14=(the amount of packets input into the server 108 from the apparatuses other than the server 108 in the data center 100)

Therefore, the function 101g for calculating the amount of packets for each apparatus uses the following formulas (8) and (9) to calculate the amounts of packets P13 and P14.

P13=P3−P11 (8)

P14=P5−P12 (9)

The amount of packets input into the server 107 from the apparatuses other than the server 107 in the data center 100 P13 is calculated by using the formula (8): 100−20=80 (MB). Similarly, the amount of packets input into the server 108 from the apparatuses other than the server 108 in the data center 100 P14 is calculated by using the formula (9): 150−=120 (MB).

Further, the amounts of packets P15, P16, P17 and P18 are defined as follows:

P15=(the amount of packets output from the server 107 to the server 108)
P16=(the amount of packets output from the server 108 to the server 107)
P17=(the total amount of packets input into the apparatuses other than the server 107 from the internal network 500)
P18=(the total amount of packets input into the apparatuses other than the server 108 from the internal network 500)

The function 101g for calculating the amount of packets for each apparatus uses the following formulas (10) and (11) to calculate the amounts of packets P15 and P16.

P15=P9×P14/P17 (10)

P16=P10×P13/P18 (11)

In the first example, it is an object to calculate the amount of packets transmitted between the servers 107 and 108. Therefore, P13=P18 and P14=P17 are achieved. And the amount of packets output from the server 107 to the server 108 P15 is calculated by using the formula (10): 133 (MB) (=P9). Similarly, the amount of packets output from the server 108 to the server 107 P16 is calculated by using the formula (11): 67 (MB) (=P10).

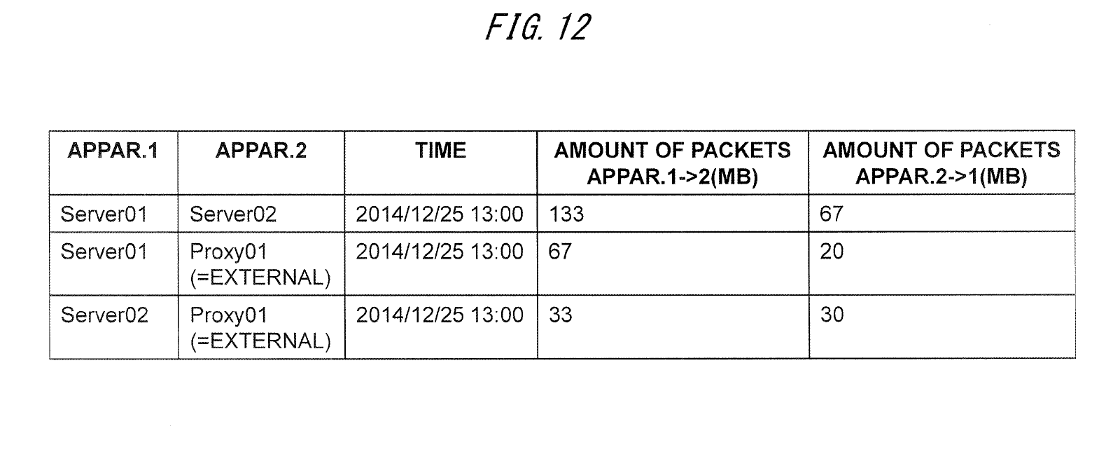

As described above, the function 101g for calculating the amount of packets for each apparatus calculates the amounts of packets transmitted between the servers 107 and 108 and stores the calculation results in the amount of packets calculation result table 101m. FIG. 12 illustrates an example of the amount of packets calculation result table 101m when the function 101g for calculating the amount of packets for each apparatus calculates the amounts of packets transmitted between two apparatuses in the data center 100.

FIG. 12 illustrates an example of the amounts of input packets and output packets per hour transmitted between two of the server 107 (the apparatus ID: “Server01”), the server 108 (the apparatus ID: “Server02”) and the proxy server 106 (the apparatus ID: “Proxy01”) in the data center 100 at 13:00 on Dec. 25, 2014 (as illustrated in the “time” column). It is noted that the amounts of packets transmitted between the server 107, the server 108 and the proxy server 106 correspond to the amounts of packets transmitted between the servers 107, 108 and the external network 600. Therefore, the amount of packets transmitted between two of the apparatuses in the data center 100 can be calculated in the first example.

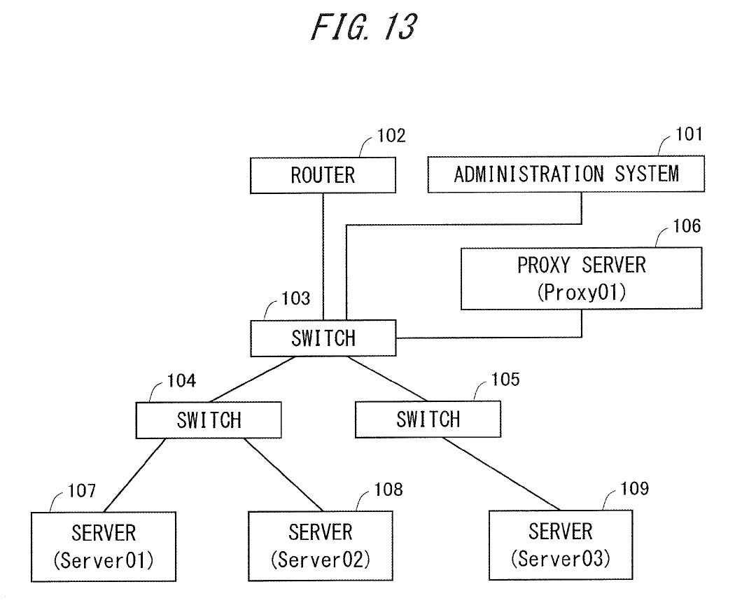

Next, the second example is described below. In the second example as illustrated in FIG. 13, the amounts of packets transmitted between two of the three servers 107, 108 and 109 in the data center 100 are calculated. It is noted that the apparatus IDs of the servers 107, 108 and 109 are “Server01”, “Server02” and “Server03”, respectively. In addition, the apparatus ID of the proxy server 106 is “Proxy01”.

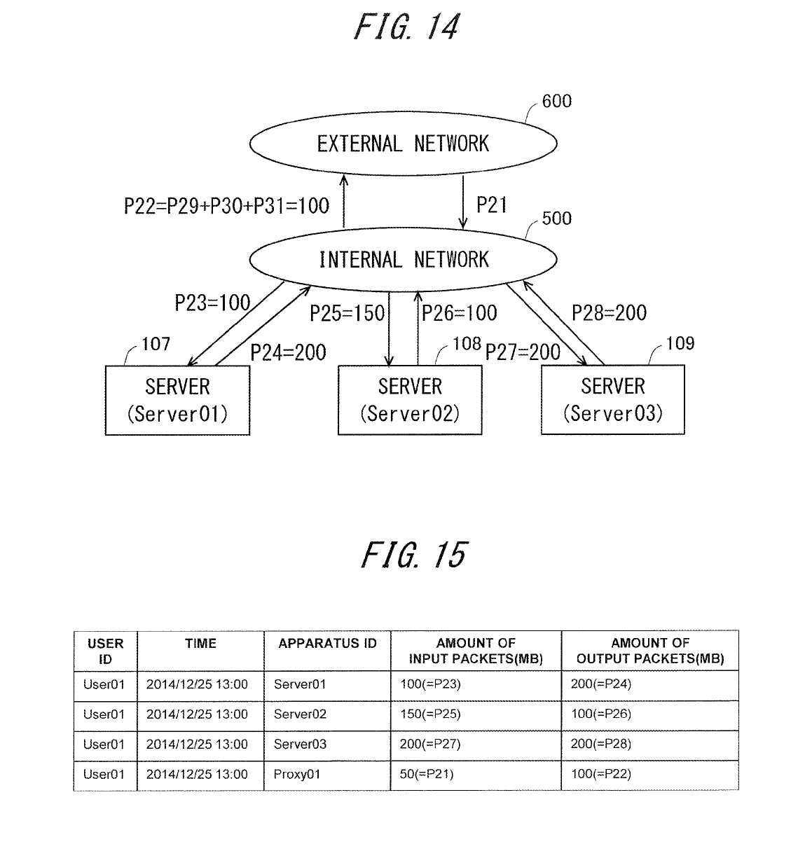

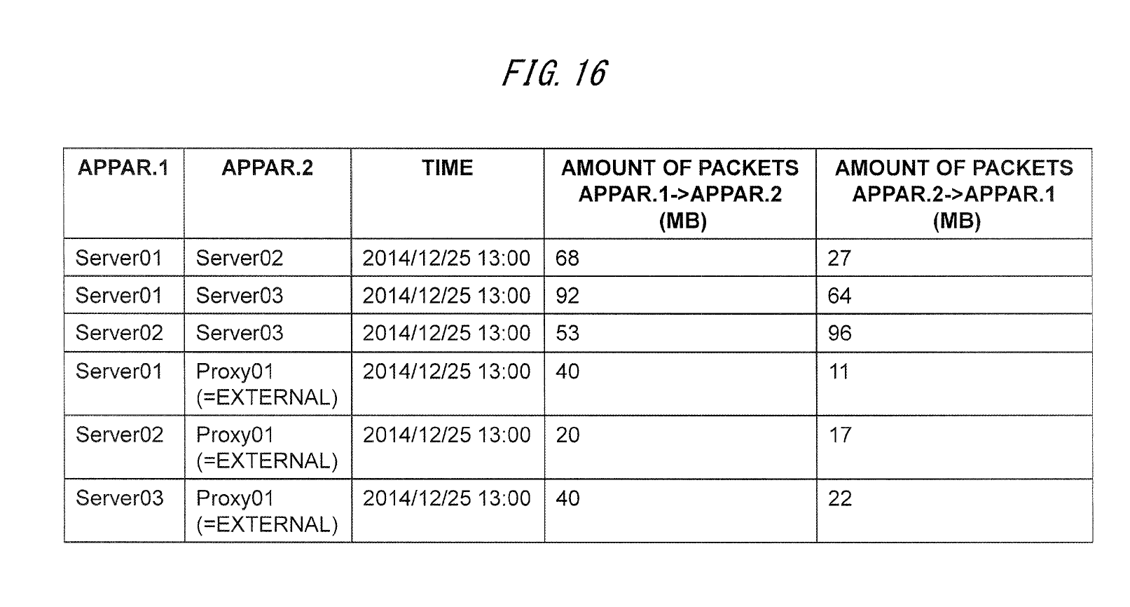

Similar to FIG. 9, FIG. 14 schematically illustrates the transmitted between the servers, the internal network and the external network at predetermined time intervals.

The administration system 101 executes the program 101e for monitoring the amount of packets to use the function 101f for gathering information of the amount of packets to acquire the information of the amounts of packets input into and output from each server 107, 108 and 109 at the predetermined time intervals. In addition, the administration system 101 uses the function 101f for gathering information of the amount of packets to acquire the information of the amounts of packets output from the proxy server 106 to the external network via the switch 103 and the router 102 at the predetermined time intervals.

As illustrated in FIG. 0.14, the amounts of packets output from the servers 107, 108 and 109 to the internal network 500 is 200 Mb, 100 Mb and 200 MB, respectively. 100 MB packets thereof are output to the external network 600. In addition, the amounts of packets input into the servers 107, 108 and 109 from the internal network 500 is 100 Mb, 150 Mb and 200 MB, respectively. It is noted that the administration system 101 can determine each amount of packets as illustrated in FIG. 14 by acquiring the statistics data of the amounts of packets from the switches 103, 104 and 105 and the proxy server 106.

As illustrated in FIG. 14, the amounts of packets transmitted at the predetermined time intervals P21, P22, P23, P24, P25, P26, P27 and P28 are defined as follows:

P21=(the amount of packets input into the internal network 500 from the external network 600)
P22=(the amount of packets output from the internal network 500 to the external network 600)
P23=(the amount of packets input into the server 107 from the internal network 500)
P24=(the amount of packets output from the server 107 to the internal network 500)
P25=(the amount of packets input into the server 108 from the internal network 500)
P26=(the amount of packets output from the server 108 to the internal network 500)
P27=(the amount of packets input into the server 109 from the internal network 500)
P28=(the amount of packets output from the server 109 to the internal network 500)

Similar to the first example, the administration system 101 cannot determine the amounts of packets input into the servers 107, 108 and 109 from the external network at the predetermined time intervals from the acquired statistics data. In addition, it is assumed in the second example that a packet is not lost in the data communication between the internal network 500 and the external network 600. That is, the total amount of packets input into the internal network 500 is equal to the total amount of packets output from the internal network 500 in FIG. 14. In this case, the following formula (12) is obtained.

P21=P22+P23+P25+P27−P24−P26−P28 (12)

In the example as illustrated in FIG. 14, the amount of packets input into the internal network 500 from the external network 600 P21 is calculated by using the formula (12): 50 MB. In addition, the administration system 101 executes the program 101e for monitoring the amount of packets to use the function 101g for calculating the amount of packets for each apparatus to calculate the amount of packets input into the internal network 500 from the external network 600 P21 at the predetermined time intervals at a given time by using the formula (12). The calculation results are stored in the amount of packets per apparatus table 101k.

In the example as illustrated in FIGS. 13 and 14, the total amount of packets output from the servers 107, 108 and 109 to the internal network 500 P24, P26 and P28 is 500 MB and 100 MB (=P22) packets thereof are output to the external network 600. However, the respective amounts of packets output from the servers 107, 108 and 109 to the external network 600 are unknown.

In the second example, the ratio of the amounts of packets output from the servers 107, 108 and 109 to the internal network 500 is used to divide the amount of packets output from the internal network 500 to the external network 600. Here, the amounts of packets P29, P30 and P31 are defined as follows:

P29=(the amount of packets output from the server 107 to the external network 600)
P30=(the amount of packets output from the server 108 to the external network 600)
P31=(the amount of packets output from the server 109 to the external network 600)

The function 101g for calculating the amount of packets for each apparatus uses the following formulas (13), (14) and (15) to calculate the amounts of packets P29, P30 and P31.

P29=P22×P24/(P24+P26+P28) (13)

P30=P22×P26/(P24+P26+P28) (14)

P31=P22×P28/(P24+P26+P28) (15)

The amount of packets output from the server 107 to the external network 600 P29 is calculated by using the formula (13): 100×⅖=40 (MB). Similarly, the amount of packets output from the server 108 to the external network 600 P30 is calculated by using the formula (14): 100×⅕=20 (MB). Further, the amount of packets output from the server 109 to the external network 600 P31 is calculated by using the formula (15): 100×⅖=40 (MB). It is noted that the values calculated by the formulas (13), (14) and (15) are rounded off to the whole number.

In addition, the amounts of packets P32, P33 and P34 are defined as follows:

P32=(the total amount of packets output from the server 107 to the apparatuses other than the server 107 in the data center 100)
P33=(the total amount of packets output from the server 108 to the apparatuses other than the server 108 in the data center 100)
P34=(the total amount of packets output from the server 109 to the apparatuses other than the server 109 in the data center 100)
Moreover, the function 101g for calculating the amount of packets for each apparatus uses the following formulas (16), (17) and (18) to calculate the amounts of packets P32, P33 and P34.

P32=P24−P29 (16)

P33=P26−P30 (17)

P34=P28−P31 (18)

It is assumed in the second example that the servers 107, 108 and 109 are the apparatuses in the data center 1000 as the targets for calculating the amounts of packets. Therefore, the apparatuses other than the server 107 in the data center are the servers 108 and 109 in the second example. In addition, the apparatuses other than the server 108 in the data center are the servers 107 and 109 in the second example. Further, the apparatuses other than the server 109 in the data center are the servers 107 and 108 in the second example.

The total amount of packets output from the server 107 to the apparatuses other than the server 107 in the data center 100 P32 is calculated by using the formula (16): 200−40=160 (MB). In addition, the total amount of packets output from the server 108 to the apparatuses other than the server 108 in the data center 100 P33 is calculated by using the formula (17): 100−20=80 (MB). Further, the total amount of packets output from the server 109 to the apparatuses other than the server 109 in the data center 100 P34 is calculated by using the formula (18): 200−40=160 (MB).

In addition, it is unknown what part of the amount of packets input into the internal network 500 from the external network 600 is input into the servers 107, 108 and 109, respectively. Therefore, the ratio of the amounts of packets output from the internal network 500 to the servers 107, 108 and 109 is used to divide the amount of packets input into the internal network 500 from the external network 600. Here, the amounts of packets P36, P37 and P38 are defined as follows:

P36=(the amount of packets input into the server 107 from the external network 600)
P37=(the amount of packets input into the server 108 from the external network 600)
P38=(the amount of packets input into the server 108 from the external network 600)

The function 101g for calculating the amount of packets for each apparatus uses the following formulas (19), (20) and (21) to calculate the amounts of packets P36, P37 and P38.

P36=P21×P23/(P23+P25+P27) (19)

P37=P21×P25/(P23+P25+P27) (20)

P38=P21×P27/(P23+P25+P27) (21)

The amount of packets input into the server 107 from the external network 600 P36 is calculated by using the formula (19): 50×100/450=11 (MB). Similarly, the amount of packets input into the server 108 from the external network 600 P37 is calculated by using the formula (20): 50×150/450=17 (MB). In addition, the amount of packets input into the server 109 from the external network 600 P38 is calculated by using the formula (21): 50×200/450=22 (MB). It is noted that the values calculated by the formulas (19), (20) and (21) are rounded off to the whole number.

Further, the amounts of packets P39, P40 and P41 are defined as follows:

P39=(the amount of packets input into the server 107 from the apparatuses other than the server 107 in the data center 100)
P40=(the amount of packets input into the server 108 from the apparatuses other than the server 108 in the data center 100)
P41=(the amount of packets input into the server 109 from the apparatuses other than the server 109 in the data center 100)

Therefore, the function 101g for calculating the amount of packets for each apparatus uses the following formulas (22), (23) and (24) to calculate the amounts of packets P39, P40 and P41.

P39=P23−P36 (22)

P40=P25−P37 (23)

P41=P27−P38 (23)

The amount of packets input into the server 107 from the apparatuses other than the server 107 in the data center 100 P39 is calculated by using the formula (22): 100−11=89 (MB). Similarly, the amount of packets input into the server 108 from the apparatuses other than the server 108 in the data center 100 P40 is calculated by using the formula (23): 150−17=133 (MB). In addition, the amount of packets input into the server 109 from the apparatuses other than the server 109 in the data center 100 P41 is calculated by using the formula (24): 200−22=178 (MB).

Further, the amounts of packets P42, P43, P44, P45, P46, P47, P48, P49 and P50 are defined as follows:

P42=(the amount of packets output from the server 107 to the server 108)
P43=(the amount of packets output from the server 107 to the server 109)
P44=(the amount of packets output from the server 108 to the server 107)
P45=(the amount of packets output from the server 108 to the server 109)
P46=(the amount of packets output from the server 109 to the server 107)
P47=(the amount of packets output from the server 109 to the server 108)
P48=(the amount of packets input into the apparatuses other than the server 107 from the internal network 500)
P49=(the amount of packets input into the apparatuses other than the server 108 from the internal network 500)
P50=(the amount of packets input into the apparatuses other than the server 109 from the internal network 500)

Therefore, the function 101g for calculating the amount of packets for each apparatus uses the following formulas (25), (26), (27), (28), (29) and (30) to calculate the amounts of packets P42, P43, P44, P45, P46 and P47.

P42=P32×P40/P48 (25)

P43=P32×P41/P48 (26)

P44=P33×P39/P49 (27)

P45=P33×P41/P49 (28)

P46=P34×P39/P50 (29)

P47=P34×P40/P50 (30)

In the second example, it is an object to calculate the amount of packets transmitted between the servers 107, 108 and 109. Therefore, P48=P40+P41, P49=P39+P41 and P50=P39+P40 are achieved. And the amounts of packets are calculated by using the formula (25), (26), (27), (28) and (29): P42=68 (MB), P43=92 (MB), P44=27 (MB), P45=53 (MB), P46=64 (MB) and P47=96 (MB), respectively.

As described above, the function 101g for calculating the amount of packets for each apparatus calculates the amounts of packets transmitted between the servers 107, 108 and 109 and stores the calculation results in the amount of packets calculation result table 101m. FIG. 15 illustrates an example of the amount of packets calculation result table 101m when the function 101g for calculating the amount of packets for each apparatus calculates the amounts of packets transmitted between two apparatuses in the data center 100.

FIG. 15 illustrates an example of the amounts of input packets and output packets per hour transmitted between two of the server 107 (the apparatus ID: “Server01”), the server 108 (the apparatus ID: “Server02”), the server 109 (the apparatus ID: “Server03”) and the proxy server 106 (the apparatus ID: “Proxy01”) in the data center 100 at 13:00 on Dec. 25, 2014 (as illustrated in the “time” column). It is noted that the amounts of packets transmitted between the server 107, the server 108, the server 109 and the proxy server 106 correspond to the amounts of packets transmitted between the servers 107, the server 108, the server 109 and the external network 600. Therefore, the amount of packets transmitted between two of the apparatuses in the data center 100 can be calculated in the first example.

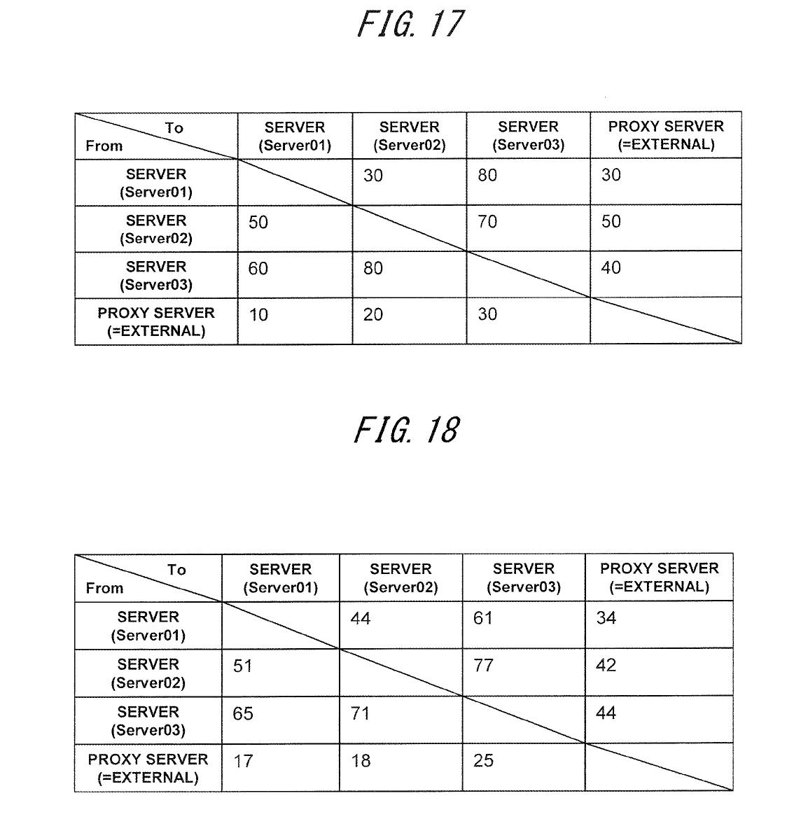

Next, the comparison between the actual measured values and the values calculated as described above of the amounts of packets transmitted between the apparatuses in the data center 100 are described below. FIG. 17 illustrates an example of the actual measured values of the amounts of packets transmitted between the apparatuses in the data center 100. The actual measured values of the amounts of packets transmitted between two of the servers 107, 108, 109 and the proxy server 106 are illustrated in FIG. 17.

Similar to the first and second examples, the statistics data obtained by the function 101f for gathering information of the amount of packets can be used to determine the total amount of packets input into or output from each server and packets output to the proxy server 106, that is, the external network 600 in the example in FIG. 17. Namely, as for the server 107 for example, the amount of packets output from the server 107 can be determined: 30+80+30=140 (MB). The amount of packets input into the server 107 can also be determined: 50+60+10=120 (MB). In addition, as for the proxy server 106 for example, the amount of packets output to the proxy server 106 can be determined: 30+50+40=120 (MB). However, the amount of packets input into or output from each server and the amount of packets input into the proxy server from each server cannot be determined.

FIG. 18 illustrates the amounts of packets input into and output from each server calculated according to the above descriptions of the second example. It is noted in FIGS. 17 and 18 that the unit of value for the amount of packets is MB. As understood from the comparison with the measured values of the amounts of packets in FIG. 17, the calculated values of the amounts of packets in FIG. 18 range within 30% of the measured values in FIG. 17. Therefore, the amounts of packets input into and output from each apparatus in the data center 100 can be estimated based on the statistics information obtained from the switches in the data center 100 in the present embodiment.

Although the present embodiment is described as above, the configurations and the processes of the data center 100 etc. are not limited to those as described above and various variations may be made to the embodiment described herein within the technical scope of the above embodiment. For example, the amounts of packets input into and output from the servers 107, 108 and 109 are calculated in the above embodiment. Other apparatuses in the data center 100 can be included as the targets for the calculation of the amounts of packets.

In addition, the amounts of packets input into and output from the three severs 107, 108 and 109 are estimated in the second example as described above. For example, when programs are executed in the servers 107, 108 and 109 to predict that packet communication does not occur between the server 108 and the server 109, it can be assumed in the second example that the amounts of packets transmitted between the server 108 and the server 109 are zero. As a result, the estimation accuracy of the amounts of packets transmitted between the server 107 and 108 can be increased in the second example.

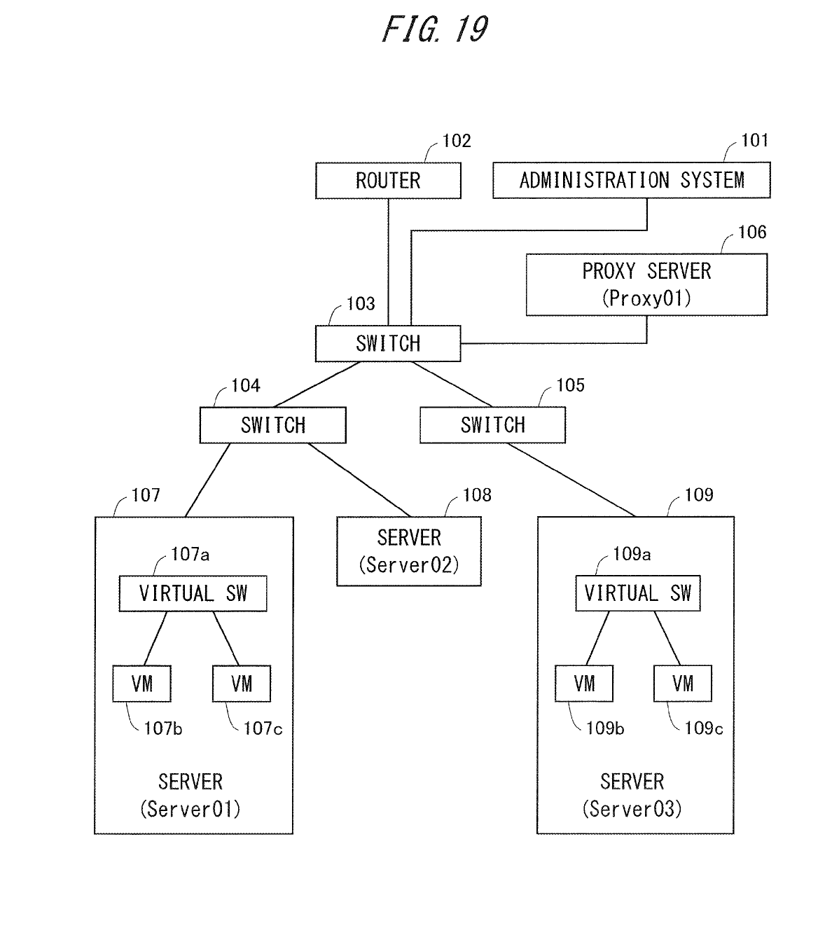

In addition, a virtual environment can be built in any of the servers 107, 108 and 109 in the data center 100 and a plurality of virtual servers and virtual switches connecting the virtual servers with each other can be configured in the above embodiment. FIG. 19 illustrates an example in which virtual environments are built in the servers 107 and 109 in the data center 100. As illustrated in FIG. 19, a virtual switch 107a, virtual machines 107b and 107c operates in the server 107. Similarly, a virtual switch 109a, virtual machines 109b and 109c operates in the server 109.

Similar to the switches 103, 104 and 105 as described above, the virtual machines 107b and 107c are connected with the ports of the virtual switch 107a. The virtual machine 107b output packets to the virtual switch 107a. The virtual switch 107a outputs packets output from the virtual machine 107b to the switch 104. The operations of the virtual machine 107c, 109b, 109c are similar to the operations of the virtual machine 107b and the operation of the virtual switch 109a is similar to the operation of the virtual switch 107a.

Further, the virtual switch 107a counts the amounts of input packets and output packets regarding the virtual machines 107b and 107c connected with the respective ports. Similarly, the virtual switch 109a counts the amounts of input packets and output packets regarding the virtual machines 109b and 109c connected with the respective ports. In addition, similar to the above embodiment, the administration system 101 acquires the statistics data of the amounts of packets from the virtual switches 107a and 109a. Therefore, the calculations as described in the above examples can be applied to the calculations of the amounts of packets transmitted between two of the apparatuses in the data center 100 including the virtual machines 107b, 107c, 109b and 109c.

Moreover, the administration system. 101 can be built in the virtual environment in the server 107 or the server 109 in the example as illustrated in FIG. 19. In this case, the user of the server 107 or the server 109 in which the virtual environment is built controls the administration system 101 to calculate the amount of packets transmitted between two of the servers 107, 108 and 109, the virtual machines 107b, 107c, 109b and 109c. Additionally, the switches 103, 104 and 105 can also be configured as virtual switches which operate in the virtual environment built as described above.

<<Computer Readable Recording Medium>>

It is possible to record a program which causes a computer to implement any of the functions described above on a computer readable recording medium. In addition, by causing the computer to read in the program from the recording medium and execute it, the function thereof can be provided.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

According to one aspect, a program of controlling an information processing apparatus for determining the validity of exclusive processes can be achieved.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing system including a relay apparatus configured to relay data between an internal network of the information processing system and an external network connecting with an external apparatus of the information processing system, a switching apparatus configured to connect with the relay apparatus via the internal network, a plurality of devices connected with a plurality ports of the switching apparatus via the internal network and an administration apparatus configured to administer information of an amount of data transmitted in the internal network, wherein
the administration apparatus comprises:
a processor; and
memory storing instructions for causing the processor to execute:
gathering information of an amount of data transmitted through the switching apparatus from the switching apparatus for each of the plurality of devices connected with the plurality ports of the switching apparatus; and
calculating an amount of data transmitted between a first device and a second device of the plurality devices based on the gathered information.

2. The information processing system according to claim 1, further comprising a proxy apparatus configured to output data transmitted to the external apparatus in place of the plurality of devices,
wherein the processor further executes:
gathering information of an amount of proxy data from the proxy apparatus, the proxy data being data transmitted and received by the proxy apparatus; and
calculating an amount of data transmitted between one of the first device and the second device and the external apparatus based on the information of the amount of data gathered from the switching apparatus and the information of the amount of proxy data gathered from the proxy apparatus.

3. The information processing system according to claim 1, wherein the processor further executes:
dividing the amount of data transmitted between the internal network and the external network among the plurality of devices connected with the plurality of ports based on the information of the amount of data gathered from the switching apparatus.

4. The information processing system according to claim 3, wherein the calculating calculates the amount of data transmitted from the first device to the second device by dividing the amount of data transmitted from the first device to the port of the switching apparatus connected with the first device among the plurality of devices other than the first device based on the amount of data transmitted from the switching apparatus to the plurality devices other than the first device.

5. The information processing system according to claim 1, wherein the switching apparatus is a virtual switch built in a virtual machine.

6. A method of controlling an information processing system including a relay apparatus configured to relay data between an internal network of the information processing system and an external network connecting with an external apparatus of the information processing system, a switching apparatus configured to connect with the relay apparatus via the internal network, a plurality of devices connected with a plurality ports of the switching apparatus via the internal network and an administration apparatus configured to administer information of an amount of data transmitted in the internal network, the method comprising:
gathering, by the administration apparatus, information of an amount of proxy data from the proxy apparatus, the proxy data being data transmitted and received by the proxy apparatus; and
calculating, by the administration apparatus, an amount of data transmitted between one of the first device and the second device and the external apparatus based on the information of the amount of data gathered from the switching apparatus and the information of the amount of proxy data gathered from the proxy apparatus.

7. The method according to claim 6, wherein the information processing system further comprises a proxy apparatus configured to output data transmitted to the external apparatus in place of the plurality of devices,
wherein the method further executes:
gathering, the administration apparatus, information of an amount of proxy data from the proxy apparatus, the proxy data being data transmitted and received by the proxy apparatus; and
calculating, the administration apparatus, an amount of data transmitted between one of the first device and the second device and the external apparatus based on the information of the amount of data gathered from the switching apparatus and the information of the amount of proxy data gathered from the proxy apparatus.

8. The method according to claim 6, wherein the method further comprises:
dividing, by the administration apparatus, the amount of data transmitted between the internal network and the external network among the plurality of devices connected with the plurality of ports based on the information of the amount of data gathered from the switching apparatus.

9. The method according to claim 8, wherein the administration apparatus calculates the amount of data transmitted from the first device to the second device by dividing the amount of data transmitted from the first device to the port of the switching apparatus connected with the first device among the plurality of devices other than the first device based on the amount of data transmitted from the switching apparatus to the plurality devices other than the first device.

10. The method according to claim 6, wherein the switching apparatus is a virtual switch built in a virtual machine.

11. A non-transitory computer-readable recording medium storing a program that causes an administration apparatus in an information processing system to execute a process, the information processing system including a relay apparatus configured to relay data between an internal network of the information processing system and an external network connecting with an external apparatus of the information processing system, a switching apparatus configured to connect with the relay apparatus via the internal network, a plurality of devices connected with a plurality ports of the switching apparatus via the internal network and the administration apparatus configured to administer information of an amount of data transmitted in the internal network, the process comprising:
gathering, by the administration apparatus, information of an amount of proxy data from the proxy apparatus, the proxy data being data transmitted and received by the proxy apparatus; and
calculating, by the administration apparatus, an amount of data transmitted between one of the first device and the second device and the external apparatus based on the information of the amount of data gathered from the switching apparatus and the information of the amount of proxy data gathered from the proxy apparatus.

12. The non-transitory computer-readable recording medium according to claim 11, wherein the information processing system further comprises a proxy apparatus configured to output data transmitted to the external apparatus in place of the plurality of devices,
wherein the method further executes:
gathering, the administration apparatus information of an amount of proxy data from the proxy apparatus, the proxy data being data transmitted and received by the proxy apparatus; and
calculating an amount of data transmitted between one of the first device and the second device and the external apparatus based on the information of the amount of data gathered from the switching apparatus and the information of the amount of proxy data gathered from the proxy apparatus.

13. The non-transitory computer-readable recording medium according to claim 11, wherein the method further comprises:
dividing, by the administration apparatus, the amount of data transmitted between the internal network and the external network among the plurality of devices connected with the plurality of ports based on the information of the amount of data gathered from the switching apparatus.

14. The non-transitory computer-readable recording medium according to claim 13, wherein the administration apparatus calculates the amount of data transmitted from the first device to the second device by dividing the amount of data transmitted from the first device to the port of the switching apparatus connected with the first device among the plurality of devices other than the first device based on the amount of data transmitted from the switching apparatus to the plurality devices other than the first device.

15. The non-transitory computer-readable recording medium according to claim 11, wherein the switching apparatus is a virtual switch built in a virtual machine.
